(19) United States
(12) Patent Application Publication
(10) Pub. No.: US 2009/0297718 A1
(43) Pub. Date: Dec. 3, 2009

(54) METHODS OF FABRICATING ENVIRONMENTAL BARRIER COATINGS FOR SILICON BASED SUBSTRATES

(75) Inventors: Reza Sarrafi-Nour, Clifton Park, NY (US); Lawrence Bernard Kool, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/128,943

(22) Filed: May 29, 2008

(51) Int. Cl. B05D 5/00; B05D 3/02; B05D 3/04

(52) U.S. Cl. 427/377; 427/397.7

(57) ABSTRACT

A method of protecting an article from a high temperature environment, the method includes providing a substrate comprising silicon, forming a slurry coating composition, wherein the composition comprises a metallic silicon powder, a rare-earth oxide, an alkaline earth metal oxide, an aluminum oxide, or a combination comprising at least one of the foregoing, and a binder effective to chemically stabilize the slurry coating, applying a layer of the slurry coating over the substrate, and heat-treating the slurry coating under conditions sufficient to oxidize the metallic silicon powder and form an alkaline earth metal aluminosilicate, a rare-earth silicate, an aluminum silicate, or a combination comprising at least one of the foregoing bonded to the substrate.

### GOVERNMENT RIGHTS

This invention was made with Government support under Government contract No. DE-FC26-05NT42643 awarded by the Department of Energy. The Government has certain rights in this invention.

### BACKGROUND OF THE INVENTION

The present disclosure relates generally to environmental barrier coatings for silicon based substrates, and more particularly, to methods of fabricating the environmental barrier coating systems for protecting substrates from exposure to high-temperature environments.

Silicon-bearing materials, such as, for example, ceramics, alloys, and intermetallics, offer attractive properties for use in structures designed for service at high temperatures in such applications as gas turbine engines, heat exchangers, and internal combustion engines, for example. However, the environment, to which these applications are exposed often contain water vapor, which at high temperatures is known to cause significant surface recession and mass loss in silicon-bearing materials. The water vapor reacts with the structural material at high temperatures to form volatile silicon-containing species, often resulting in unacceptably high recession rates.

Environmental barrier coatings (EBCs) are applied to silicon-bearing materials susceptible to attack by high temperature water vapor, and provide protection by prohibiting contact between the water vapor and the surface of the material. EBCs are designed to be relatively stable chemically in high-temperature, water vapor-containing environments and to minimize connected porosity and vertical cracks, which provide exposure paths between the material surface and the environment. Cracking is minimized in part by minimizing the thermal expansion mismatch between the EBC and the underlying material. Improved adhesion and environmental resistance can be achieved through the use of multiple layers of different materials. Various silicate EBCs have been developed for application to silicon-based ceramic materials such as silicon carbide composites and silicon nitride components for gas turbines. Some examples of these coatings include barium-strontium aluminosilicate, mullite, rare-earth disilicates and rare-earth monosilicates wherein the rare earth elements can be selected from Y, Gd, Tb, Dy, Ho, Er, Tm, Yb and Lu.

Current EBC deposition technology on such ceramic matrix composite substrates can rely heavily on plasma-spray deposition methods. A plasma spray process can have several limitations and disadvantages particular to EBC applications and requirements. A particular limitation is that plasma spraying is a line-of-sight process, thereby limiting the utility of the technique to substrates with simple geometries, or substrates only requiring a coating on the external features. Achieving a hermetic, gas-tight ceramic coating microstructure using plasma spray deposition is very difficult because the coating microstructure includes a variety of open defects, such as micro-cracks, macro-cracks, interlayer gaps, interlamellar gaps, and the like, that are inherent to the plasma spray deposition process.

Another limitation of plasma spraying EBC is that the coating materials deposited by the method are prone to undesirable changes in chemistry and structure owing to intense heating of the particles in the plasma plume, as well as to the rapid quenching of the molten particles on a substrate. The coating material deposited using plasma spraying is often inherently in a thermodynamically metastable state (such as an amorphous phase, a higher temperature phase, or one or more non-equilibrium phases) due to rapid quenching during the spray process. Upon exposure to high temperature, transformation toward the equilibrium state occurs, and the constrained coating can undergo a variety of dimensional changes resulting in stresses in the coating that can lead to various types of cracking behavior. The propensity of the coating to crack tends to be proportional to the coating thickness. Additionally, the coatings processed by plasma spraying are prone to contain open porosity and/or a network of fine cracks intercepting the otherwise closed pores and voids. For EBC applications open porosity in the coating can be detrimental. The open porosity provides a path for rapid water vapor penetration and, hence, accelerated localized degradation and/or deterioration of the underlying materials making them prone to environmental attacks such as water vapor mediated oxidation and volatilization.

### BRIEF DESCRIPTION OF THE INVENTION

Disclosed herein are methods of fabricating an environmental barrier coating on a silicon-based substrate. In one embodiment the method includes protecting an article from a high temperature environment by providing a substrate comprising silicon, forming a slurry coating composition, wherein the composition comprises a metallic silicon powder, a rare-earth oxide, an alkaline earth metal oxide, an aluminum oxide, or a combination comprising at least one of the foregoing, and a binder effective to chemically stabilize the slurry coating, applying a layer of the slurry coating over the substrate, and heat-treating the slurry coating under conditions sufficient to oxidize the metallic silicon powder and form an alkaline earth metal aluminosilicate, a rare-earth silicate, an aluminum silicate, or a combination comprising at least one of the foregoing bonded to the substrate.

In another embodiment, a method of fabricating an environmental barrier coating on a substrate includes providing the substrate, wherein the substrate comprises silicon; forming a water based slurry coating composition, wherein the composition comprises a metallic silicon powder, a rare-earth oxide, an alkaline earth metal oxide, an aluminum oxide, or a combination comprising at least one of the foregoing, and a binder effective to chemically stabilize the slurry coating; disposing a bond layer over the substrate, wherein the bond layer comprises a silicon metal; disposing a layer of the slurry coating over the bond layer; and heat-treating the slurry coating under conditions sufficient to oxidize the metallic silicon powder and form an alkaline earth metal aluminosilicate, a rare-earth silicate, an aluminum silicate, or a combination comprising at least one of the foregoing bonded to the substrate.

In still another embodiment, a method of fabricating an environmental barrier coating on a substrate includes providing the substrate, wherein the substrate comprises silicon; forming a water based slurry coating composition, wherein the composition comprises a metallic silicon powder, a rare-earth oxide, an alkaline earth metal oxide, an aluminum oxide, or a combination comprising at least one of the foregoing, and a binder effective to chemically stabilize the slurry coating; pre-oxidizing the substrate to form a bond layer; applying a layer of the slurry coating over the bond layer; and heat-treating the slurry coating under conditions sufficient to oxidize the metallic silicon powder and form an alkaline earth metal aluminosilicate, a rare-earth silicate, an aluminum silicate, or a combination comprising at least one of the foregoing bonded to the substrate.

The above described and other features are exemplified by the following figures and detailed description.

### BRIEF DESCRIPTION OF THE DRAWINGS

Referring now to the figures wherein the like elements are numbered alike:

FIG. 1 is a cross-sectional schematic of an article having an environmental barrier coating fabricated by the process of the present disclosure;

FIG. 2 is a cross-sectional image of an exemplary reaction bonded mullite environmental barrier coating; and

FIG. 3 is an x-ray diffraction pattern taken from the reaction formed mullite EBC layer of FIG. 2.

### DETAILED DESCRIPTION OF THE INVENTION

The present disclosure relates to an environmental barrier coating (EBC) fabrication process for silicon based substrates where the total shrinkage of the coating during fabrication by a slurry deposition method and sintering at high temperatures is minimized, thereby permitting thicker coatings that lack the severe cracking associated with current coating processes. As an alternative to plasma spray deposition, EBCs fabricated by the method disclosed herein can address the above described limitations of the plasma spray process while simultaneously accommodating fabrication of thick coatings, i.e., coatings having thicknesses of about 75 micrometers to about 150 micrometers that are needed for current EBC high-temperature applications. Particularly, the method is directed to fabricating an environmental and/or thermal barrier coating that can be disposed on a silicon-containing substrate.

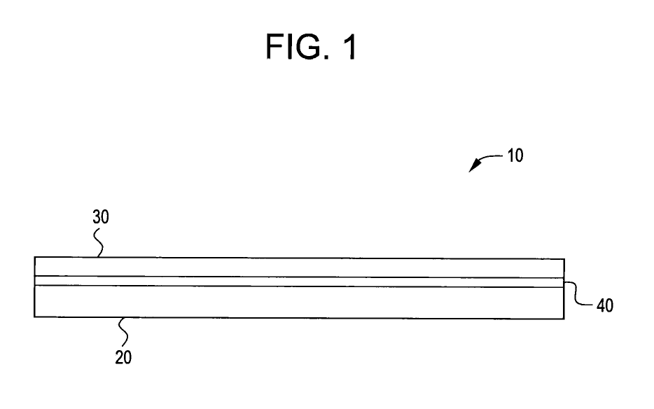

Referring to FIG. 1, one embodiment of the present disclosure is an article 10 for use in a high-temperature environment comprising a substrate 20 comprising silicon. In certain embodiments, substrate 20 comprises at least one of silicon nitride, molybdenum disilicide, and silicon carbide. One particularly suitable substrate material is a ceramic matrix composite material comprising a silicon carbide matrix reinforced with fibers comprising silicon carbide, although other combinations of silicon-bearing ceramic matrix material and fiber reinforcement material are suitable as well. In particular embodiments of the present disclosure, substrate 20 comprises a component of a gas turbine engine, such as, for example, a combustion liner, combustion dome, shroud, or an airfoil component such as a nozzle, bucket, vane or blade.

The article 10 further comprises a barrier layer 30 disposed over the substrate 20. In this embodiment, an optional bond layer 40 is also shown for enhancing the adhesion and barrier properties of the barrier layer. In another embodiment, the article 10 has no bond layer. In still another embodiment, the article 10 can have multiple barrier layers. Regardless of the number of layers, the barrier layer and the optional bond layer serve to form the environmental barrier coating (EBC). The EBC is the primary barrier between the environment and substrate 20, and therefore is selected to have high resistance to water vapor and extreme temperature conditions.

In one embodiment, a method of forming the EBC on a silicon containing substrate includes forming a slurry comprising metallic silicon; applying the slurry to the substrate; and heat treating the slurry to form the EBC. The use of a slurry application is desirable because the coating can be prepared economically, and can be easily applied to the substrate using a variety of deposition methods, such as dip coating, air- and air-less spraying, brushing, application by a roller, and the like. Some of these application techniques can facilitate a non-line of sight process. The slurry can then be reaction bonded to form the EBC on the silicon containing substrate.

The EBC coating slurry composition advantageously comprises a metallic silicon, as opposed to silicon oxide, which is often used in current EBC coating processes. During the reaction bonding step (i.e., the heat treating to react and sinter the coating to the substrate), the metallic silicon oxidizes from silicon to silica as the green coating is exposed to elevated temperatures. As used herein “green coating” is used to generally refer to the coating when it has dried enough that it can be handled and moved without damage to the coating layer, but before the coating has been heat treated. Such a term is well known to those having skill in the art. Upon oxidation to silica, a volume expansion in the coating occurs as a result of the composition change. The positive volume change experienced during the reaction bonding of the coating can compensate for the negative volume change that would otherwise have been encountered due to shrinkage upon sintering. In other words, the presence of metallic silicon prevents the coating layer from undergoing the shrinking that normally occurs during sintering of coating layers applied using conventional processes of obtaining a “green” coating body. For current processes, one of the key challenges in depositing EBC coatings on a substrate and trying to sinter the coating layer is the amount of shrinkage the layer must undergo to prevent open porosity and hence achieve high density. Excessive shrinkage of coating layers sintered on rigid substrates is known to lead to various types of cracking, jeopardizing both the integrity of the coating layer and its protective barrier properties in an EBC application. The coating application method as disclosed herein advantageously nullifies some of this shrinkage, therefore, the coating layer has a better chance of surviving the sintering operation and can even allow for the fabrication of thicker coatings in each sintering pass.

The EBCs that can be fabricated by the method described herein can include, without limitation, mullite, alkaline-earth aluminosilicates, rare-earth silicates, and the like. Examples of alkaline-earth aluminosilicates can include, without limitation, barium-aluminosilicates, strontium aluminosilicate and barium-strontium aluminosilicates. As used herein “rare-earth silicates” is intended to generally refer to chemical compounds that comprise any of the silicate species, such as, for example, monosilicate, disilicate, orthosilicate, metasilicate, polysilicate, apatite phase, and the like, and one or more rare-earth elements. “Rare-earth elements”, as used herein, can include scandium, yttrium, and any element or elements from the lanthanide series (atomic numbers 57-71). A rare-earth silicate can be a rare-earth monosilicate (RE₂SiO₅, where RE signifies at least one rare-earth element), a rare-earth disilicate (RE₂Si₂O₇), or a combination of these. Examples of rare-earth monosilicates can include lutetium monosilicate, ytterbium monosilicate, yttrium monosilicate, and combinations thereof. Examples of rare-earth disilicates can include lutetium disilicate, ytterbium disilicate, yttrium disilicate, and combinations thereof. Mullite is another exemplary environmental barrier coating material. Mullite is an aluminosilicate with a nominal formula comprised of three moles of alumina and two moles silica (Al₆Si₂O₁₃). However, mullite is known to also refer to a range of compositions in the Al₂O₃—SiO₂ phase diagram around the nominal stoichiometric composition noted above. Additional examples can include mullite-containing mixed silicates, for example, without limitation, mullite-barium strontium aluminosilicate, mullite-yttrium silicate, mullite-calcium aluminsilicate, and the like.

The silica (SiO₂) content of the desired EBC composition can be introduced to the raw materials of the coating composition in the form of metallic silicon powder. In an exemplary embodiment, the metallic Si is added to the composition as metallic silicon powder. The total silicon content of the EBC composition, however, can be introduced through multiple sources. For example, the silicon can also be introduced to the composition as a powder alloyed with other metallic elements. Or the silicon can be introduced in quantities as a component of the binder, e.g., colloidal silica. A large portion (defined below) of the silicon content, however, should be supplied in the elemental metallic powder form in order to take advantage of the positive volume change during oxidation to silica as described herein. The powder is formed from silicon particles, and serves as a main source of silica in the coating composition. The content and the size of the powder particles will depend on several factors, such as the particular slurry deposition technique by which the coating is applied to the substrate; the identity of the other components present in the coating; the rheology of the slurry; the desired composition of the coating layer; and the like. For example, in the case of mullite, the silicon content would be about 2 moles of silicon per 3 moles of alumina. In the case of rare-earth discilicates, the silicon content would be about 1 mole of silicon for each mole of RE₂O₃. In an exemplary embodiment, a weight percentage of silicon in the EBC slurry composition can be in a range of about 40 percent by weight (wt. %) to about 80 wt. %, specifically about 50 wt. % to about 75 wt. %, and more specifically about 55 wt. % to about 65 wt. %.

As stated previously, one of the advantages of the disclosed process is that the EBC composition can be applied as a slurry, particularly a water-based slurry. The wet slurry coating composition can be applied to the surface of the substrate using any slurry deposition technique. For example, without limitation, the slurry coating composition can be brush painted, dipped, sprayed, poured, roller coated, spun coated, or the like onto the substrate surface. Regardless of the deposition technique, however, the coating composition can require additional components that permit the fine metallic silicon powder to remain stable in the slurry water. When metals and silicon are in powder form the particles can react with the water to make the slurry unsafe, even generating excessive amounts of gases, such as hydrogen. Moreover, they can thicken or solidify relatively quickly, making them difficult to apply to a substrate, e.g., by spray techniques. The coating compositions described herein, therefore, are chemically stabilized in their aqueous slurry form. The stability of the slurry can be adjusted, as known in the art by those skillful in processing of ceramic slurries, using the ratio of the solid particles to the liquid vehicle, the introduction of deflocculating agents such as organic and inorganic poly electrolytes and organic polymers that give esteric repulsive forces between the particles, and wetting and de-foaming agents. Such additives are usually introduced in the slurry composition in an amount ranging between about 0 to about 10 wt. %, and in the form of a solution or a solid that can be dissolved in the carrier liquid (often referred to as the vehicle). As used herein, compositions that are “chemically stabilized” are those that are substantially free of undesirable physical and chemical reactions leading to settling of the slurry. These are reactions that would increase the viscosity and/or the temperature of the composition to unacceptable levels. For example, unacceptable increases in temperature or viscosity are those that could prevent the composition from being easily applied to the substrate, e.g., by spraying. As a very general guideline, compositions that are deemed to be unstable are those which exhibit a temperature increase of greater than about 10 degrees Celsius (° C.) within about 1 minute, or greater than about 30° C. within about 10 minutes. In the alternative (or in conjunction with the temperature increase), these compositions may also exhibit unacceptable increases in viscosity over the same time period. (As those skilled in the chemical arts understand, the increases in temperature and viscosity may begin to occur after a short induction period).

To improve the adhesion and processability of the green coating layer, a binder can be added to the slurry composition. A certain level of green strength is required for the coating in order to handle the article during the coating fabrication process. In exemplary embodiments, the binder comprises colloidal silica. The term “colloidal silica” is meant to embrace any dispersion of fine particles of silica in a medium of water or another solvent. In such embodiments, the composition is typically aqueous. In other words, it includes a liquid carrier, which is primarily water, i.e., the medium in which the colloidal silica is often employed. As used herein, “aqueous” refers to compositions in which at least about 65% of the volatile components are water. In one embodiment, at least about 80% of the volatile components are water. Thus, a limited amount of other liquids may be used in admixture with the water. Non-limiting examples of the other liquids or “carriers” include alcohols, e.g., lower alcohols with 1-4 carbon atoms in the main chain, such as ethanol. Halogenated hydrocarbon solvents are another example.

Selection of a particular carrier composition will depend on various factors, such as: the evaporation rate required during treatment of the substrate with the composition; the effect of the carrier on the adhesion of the composition to the substrate; the solubility of additives and other components in the carrier; the “dispersability” of powders in the carrier; the carrier's ability to wet the substrate and modify the rheology of the composition; as well as handling requirements; cost requirements; and environmental/safety concerns. Those of ordinary skill in the art can select the most appropriate carrier composition by considering these factors. The amount of liquid carrier employed is usually the minimum amount sufficient to keep the solid components of slurry in suspension. Amounts greater than that level may be used to adjust the viscosity of the composition, depending on the technique used to apply the composition to a substrate. In general, the liquid carrier will comprise about 20 wt. % to about 60 wt. % by weight of the entire composition, specifically about 25 wt. % to about 50 wt. %, and more specifically about 35 wt % to about 45 wt. %.

Dispersions of colloidal silica are available from various chemical manufacturers, in either acidic or basic form. Moreover, various shapes of silica particles can be used, for example, spherical, hollow, porous, rod, plate, flake, or fibrous, as well as amorphous silica powder. The particles usually (but not always) have an average particle size in the range of about 10 nanometers to about 100 nanometers. The amount of colloidal silica present in the composition will depend on various factors. They include, for example: the amount of metallic silicon powder being used. Processing conditions are also a consideration. Usually, the colloidal silica is present at a level in the range of about 1% by weight to about 20% by weight, based on silica solids as a percentage of the entire composition. In more specific embodiments, the amount is in the range of about 10% by weight to about 15% by weight.

A variety of additional components can be added to the coating composition. Most of them are well-known in the areas of chemical processing and ceramics processing. Non-limiting examples of these additives are pigments, diluents, curing agents, dispersants, deflocculants, anti-settling agents, anti-foaming agents, plasticizers, emollients, surfactants, driers, extenders, and lubricants. In general, the additives are used at a level in the range of about 0.01% by weight to about 10% by weight, based on the weight of the entire composition.

In another more specific aspect, the composition further comprises at least one organic stabilizer, which contains at least two hydroxyl groups. In still more specific examples which may be used either separately or in combination, the organic stabilizer includes at least three hydroxyl groups; the organic stabilizer is selected from the group consisting of alkane diols, glycerol, pentaerythritol, fats, and carbohydrates. The carbohydrate can be a sugar compound. The organic stabilizer can be present in the slurry in an amount sufficient to chemically stabilize the metallic silicon powder during contact with any aqueous component present in the composition. In an exemplary embodiment, the organic stabilizer is present at a level in the range of about 0.1% by weight to about 20% by weight, based on the total weight of the composition.

To reiterate, the slurry coating composition will vary and can depend in large part on the deposition method chosen for applying the slurry to the substrate.

The silicon containing substrate can be cleaned prior to application of the barrier layer to remove substrate fabrication contamination. An exemplary method is subjecting the substrate to a grit blasting step prior to application of the barrier layer. The grit blasting step should be carried out carefully in order to avoid damage to the surface of the silicon-containing substrate such as silicon carbide fiber reinforced composite. It has been found that the particles used for the grit blasting should not be as hard as the substrate material to prevent erosive removal of the substrate and the particles must be small to prevent impact damage to the substrate. When processing an article comprising a silicon carbide ceramic substrate, it has been found that the grit blasting should be carried out with Al₂O₃ particles, preferably of a particle size of ≦30 microns and, preferably, at a velocity of about 150 to 200 meters per second. In addition to the foregoing, it may be particularly useful to pre-oxidize the silicon based substrate prior to application of the barrier layer in order to improve adherence on physico-chemical interactions between the coating and the substrate during the coating deposition and sintering steps. A bond layer, such as that shown in FIG. 1 and depicted by reference numeral 40, can be used for such a purpose. An exemplary bond layer can include silicon metal in a thickness of about 2 to about 6 mils. The Si-bond layer can be applied using a variety of deposition methods. Non limiting examples of silicon deposition methods are physical vapor deposition (PVD), chemical vapor deposition (CVD), thermal spray deposition, slurry deposition, and other like methods. Alternatively, the silicon containing substrate can be pre-oxidized to provide a SiO₂ bond layer prior to application of the barrier layer. The pre-oxidized bond layers can have a thickness between 100 nanometers to 2000 nanometers. SiO₂ bond layers of the desired thickness can be achieved by pre-oxidizing the silicon-carbide substrate at a temperature of between 800° C. to 1200° C. for about 15 minutes to 100 hours.

After application of the desired layers to the silicon based substrate material, the article can be subjected to heat treatment to promote sintering of the deposited layer and bonding between the deposited coating layers and the substrate. The coating can be submitted to heat treatment at elevated temperatures in the range of about 1000° C. to about 1600° C., specifically about 1300° C. to about 1400° C. The duration of heat treatment can be in the range of about 0.5 hours to about 8 hours, depending on the composition and the firing temperature. The heat treatment is effective to sinter the coating and bond the coating to the substrate by reacting the metallic silicon (e.g., oxidation and other chemical reactions amongst constituents of the coating composition). Using the reaction bonded mullite as an example; increase in the temperature of a mullite coating composition will oxidize silicon to silica. The forming silica layer will start to react with the other oxide constituents of the composition, in the case of mullite, alumina to either directly form the reaction product (i.e., mullite), or form transient liquid phases, such as those formed in the presence of rare-earth oxide additives, during which mullite is formed and precipitates out. Formation of such transient liquid phases could be particularly beneficial to both the densification of the coating layer and its bonding to the other coating layers and/or the substrate. For example, when the reaction bonded coating is applied onto a silicon-bearing substrate or on the Si-bond layer, the liquid phase can chemically interact with the silicon-containing material leading to local mass transport by solution-precipitation and diffusion through the liquid phase, enhancing the bonding. However, care has to be exercised on the composition and the amount of the liquid phase to avoid detrimental effects. Some diffusion of metallic silicon into the substrate surface can occur prior to oxidation to silica. This diffusion prior to oxidation can further enhance adhesion of the coating to the substrate.

Unlike many coating fabrication processes involving slurry deposition and solid-state sintering of the coating layer, the method as disclosed herein takes advantage of the increased volume created by the oxidation of silicon to form silica. As such, the thickness of the coating layer can be greater compared to current coating deposition and sintering techniques. In current solid state sintering, the thickness of the layer is limited by the amount of sintering each layer can withstand before cracking. Cracking is generally proportional to the thickness of the layer. For current coating deposition techniques, only a layer of about 5 to about 10 micrometers (μm) can be applied per sintering cycle. In other words, if the target coating layer thickness is 50 μm, using current techniques the coating may have to be applied in 3 or 4 application passes that include 3 or 4 sintering steps. Advantageously, the method as disclosed herein allows the deposition of a thicker layer, which can be sintered in a single cycle. Nullifying the total shrinkage of the EBC system permits the application of thicker barrier layers.

The following example serves to illustrate the features and advantages offered by the embodiments of the present disclosure, and are not intended to limit the invention thereto.

### EXAMPLES

### Example 1

The method described herein was evaluated by reaction bonding mullite (RBM) to a ceramic matrix composite substrate comprising a silicon carbide reinforced with fibers comprising silicon carbide (SiC—SiC CMC). A slurry was prepared by mixing 2.55 moles (M) of a metallic silicon powder, 1.85 M aluminum oxide (Al₂O₃), 0.15 M RE₂O₃ (wherein the rare earth oxide can be selected to be yttrium oxide, ytterbium oxide, and/or lutetium oxide) together with 40 to 60 percent by total weight (wt. %) water, 1 to 2 wt. % colloidal silica as binder, and 0.1 to 1 wt. % Octanol® as a de-foaming agent. The solid and liquid constituents were mixed in a plastic container on a standard bench-top paint shaker for about 15 minutes using 2 millimeter (mm) diameter milling media. Upon complete mixing, the Octanol was added to the resulting slurry and the slurry was stirred further for homogenization. Colloidal silica was used as a binder and was 30% (w/w) in water. The colloidal silica was LP30, manufactured by Remasol.

The CMC substrate was cleaned by grit blasting and degreased prior to application of the slurry. The slurry mixture was then air-sprayed on 0.5 inch (in.) by 0.5 in. by 0.1 in CMC coupons. The slurry coating was applied in two successive layers with an intermittent drying step at ambient temperature for approximately 5 minutes. The coated coupons were then dried at 110 degrees Celsius (° C.) for 1 hour. The reaction bonding/sintering was conducted in air atmosphere at a temperature of 1370° C. for 2 hours using 10° C. per minute for heating and cooling rates. Sintering for the entire coating layer was advantageously accomplished in one sintering cycle.

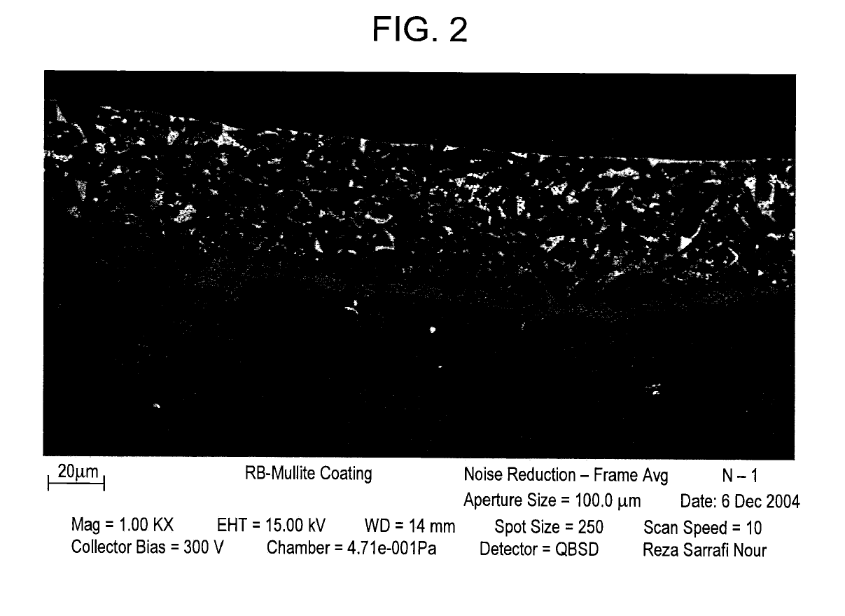

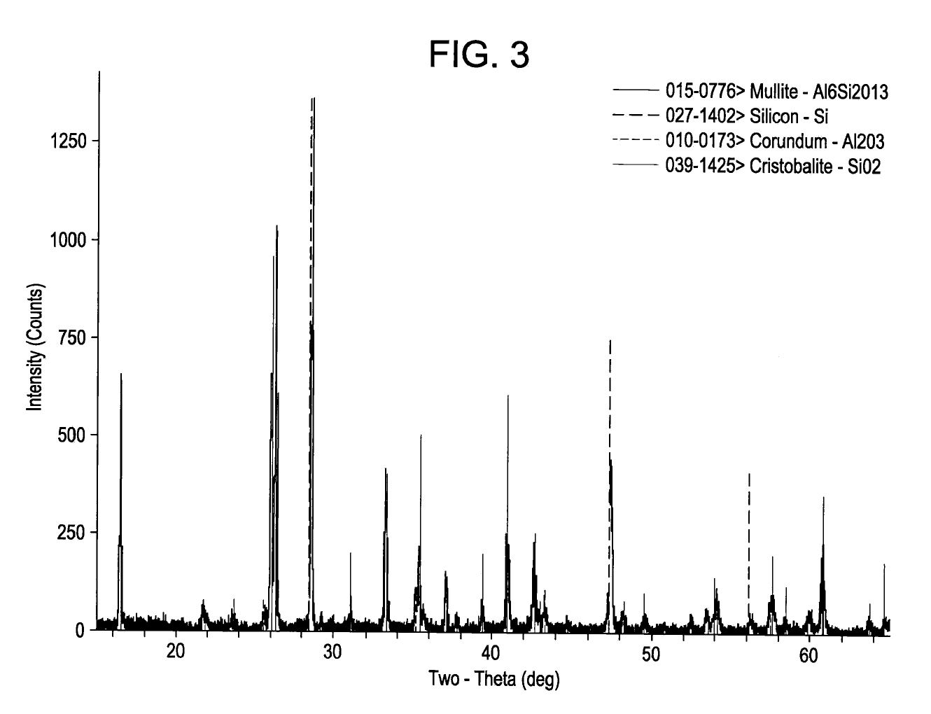

FIG. 2 shows a micrograph image of a cross section of the reaction bonded mullite coating on the CMC substrate. The micrograph illustrates the improved microstructual homogeneity of the RBM coating, wherein the exemplary method has formed a gas-hermetic coating microstructure. The image illustrates the closed pores of the RBM coating, providing a lower porosity than seen with current EBC fabrication techniques. The coating microstructure consists of mullite needles and another grain boundary phase, occasionally identified as Y₂SiO₇ or an amorphous phase. FIG. 3 shows a diffraction pattern obtained from the RBM coating sample described in the example. The silicon presence shown in the diagram can be attributed to melting of silicon alloy in the CMC substrate and its subsequent flow towards the surface

Ranges disclosed herein are inclusive and combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While the invention has been described with reference to a preferred embodiment, it will be understood that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of protecting an article from a high temperature environment, the method comprising:
providing a substrate comprising silicon;
forming a slurry coating composition, wherein the composition comprises:
a metallic silicon powder;
a rare-earth oxide, an alkaline earth metal oxide, an aluminum oxide, or a combination comprising at least one of the foregoing; and
a binder effective to chemically stabilize the slurry coating;
applying a layer of the slurry coating over the substrate; and
heat-treating the slurry coating under conditions sufficient to oxidize the metallic silicon powder and form an alkaline earth metal aluminosilicate, a rare-earth silicate, an aluminum silicate, or a combination comprising at least one of the foregoing bonded to the substrate.

2. The method of claim 1, wherein applying the layer further comprises spraying, slip-casting, brush-painting, dipping, pouring, rolling, spin coating, or a combination comprising at least one of the foregoing techniques.

3. The method of claim 1, wherein the binder comprises a colloidal silica present at a level in a range of about 1% by weight to about 20% by weight, based on silica solids as a percentage of the entire slurry composition.

4. The method of claim 1, wherein the slurry coating composition further comprises an organic stabilizer comprising an alkane diol, a glycerol, a pentaerythritol, a fat, a carbohydrate, or a combination comprising at least one of the foregoing.

5. The method of claim 1, further comprising cleaning the substrate prior to applying the slurry coating composition.

6. The method of claim 1, wherein the heat treatment is carried out an oxygen-bearing atmosphere at a temperature of about 1000 degrees Celsius to about 1600 degrees Celsius.

7. The method of claim 1, wherein the metallic silicon powder comprises a plurality of silicon particles.

8. The method of claim 7, wherein the particles are spherical, hollow, porous, rod-like, plate-like, flakes, fibrous, or a combination comprising at least one of the foregoing.

9. The method of claim 1, wherein the alkaline earth metal aluminosilicate comprises barium, strontium, barium-strontium aluminosilicate, or a combination comprising at least one of the foregoing.

10. The method of claim 1, wherein the rare-earth silicate comprises a monosilicate of yttrium, ytterbium, lutetium, erbium, dysprosium, a disilicate of yttrium, ytterbium, lutetium, erbium, dysprosium, or a combination comprising at least one of the foregoing.

11. The method of claim 1, wherein the aluminum silicate comprises mullite, mullite-barium strontium aluminosilicate, mullite-yttrium silicate, mullite-calcium aluminosilicate, or a combination comprising at least one of the foregoing.

12. The method of claim 1, wherein the slurry coating layer undergoes less than about 5% shrinkage during the heat treatment.

13. A method of fabricating an environmental barrier coating on a substrate, the method comprising:
providing the substrate, wherein the substrate comprises silicon;
forming a water based slurry coating composition, wherein the composition comprises:
a metallic silicon powder;
a rare-earth oxide, an alkaline earth metal oxide, an aluminum oxide, or a combination comprising at least one of the foregoing; and
a binder effective to chemically stabilize the slurry coating;
disposing a bond layer over the substrate, wherein the bond layer comprises a silicon metal;
disposing a layer of the slurry coating over the bond layer; and
heat-treating the slurry coating under conditions sufficient to oxidize the metallic silicon powder and form an alkaline earth metal aluminosilicate, a rare-earth silicate, an aluminum silicate, or a combination comprising at least one of the foregoing bonded to the substrate.

14. The method of claim 13, further comprising cleaning the substrate prior to disposing the coating layer and/or bond layer.

15. The method of claim 13, wherein the bond layer has a thickness of about 2 to about 6 mils.

16. The method of claim 13, disposing the slurry coating layer further comprises spraying, slip-casting, brush-painting, dipping, pouring, rolling, spin coating, or a combination comprising at least one of the foregoing techniques.

17. The method of claim 13, wherein the metallic silicon powder comprises a plurality of silicon particles, wherein the particles are spherical, hollow, porous, rod-like, plate-like, flakes, fibrous, or a combination comprising at least one of the foregoing.

18. The method of claim 13, wherein the slurry coating layer undergoes less than about 5% shrinkage during the heat treatment.

19. The method of claim 13, wherein the substrate is a turbine engine component.

20. A method of fabricating an environmental barrier coating on a substrate, the method comprising:
providing the substrate, wherein the substrate comprises silicon;
forming a water based slurry coating composition, wherein the composition comprises:
a metallic silicon powder;
a rare-earth oxide, an alkaline earth metal oxide, an aluminum oxide, or a combination comprising at least one of the foregoing; and
a binder effective to chemically stabilize the slurry coating;
pre-oxidizing the substrate to form a bond layer;
applying a layer of the slurry coating over the bond layer; and
heat-treating the slurry coating under conditions sufficient to oxidize the metallic silicon powder and form an alkaline earth metal aluminosilicate, a rare-earth silicate, an aluminum silicate, or a combination comprising at least one of the foregoing bonded to the substrate.
